(19) United States
(12) Patent Application Publication
(10) Pub. No.: US 2023/0254559 A1
(43) Pub. Date: Aug. 10, 2023

(54) IMAGE-INFORMATION-ACQUISTION-TYPE FASTENING MEANS AND MONITORING SYSTEM

(71) Applicant: NejiLaw Inc., Bunkyo-ku, Tokyo (JP)

(72) Inventor: Hiroshi Michiwaki, Bunkyo-ku, Tokyo (JP)

(21) Appl. No.: 17/768,817

(22) PCT Filed: Oct. 16, 2020
(86) PCT No.: PCT/JP2020/039166

§ 371 Date: Sep. 13, 2022

(30) Foreign Application Priority Data
Oct. 16, 2019 (JP) 2019-189798

(51) Int. Cl. H04N 5/225; F16B 31/02

(52) U.S. Cl. CPC H04N 23/54; F16B 31/02; H04N 23/55; H04N 23/61

(57) ABSTRACT

The present disclosure comprises: a fastening body that has a screw part that can be attached to a component; an imaging unit that is integrated with or separate from the fastening body and captures images of the surroundings to acquire image information; and a transmission unit that transmits the image information acquired by the imaging unit to the outside.

### CROSS REFERENCE TO RELATED APPLICATIONS

This application is a national phase entry under 35 U.S.C. § 371 of International Patent Application PCT/JP2020/039166, filed Oct. 16, 2020, designating the United States of America and published as International Patent Publication WO 2021/075570 A1 on Apr. 22, 2021, which claims the benefit under Article 8 of the Patent Cooperation Treaty to Japanese Patent Application Serial No. 2019-189798, filed Oct. 16, 2019.

### TECHNICAL FIELD

The following description relates to an image-information-acquisition-type fastening member and a monitoring system.

### BACKGROUND

Currently, various types of members are being used in various situations, such as buildings that form spaces such as buildings, houses, halls, and the like, or constructions such as bridges, iron towers, and dams (hereinafter referred to as constructions), and various means of transports including vehicles such as automobiles, bicycles, and railways, mechanical equipment, electric devices, power generation equipment, chemical plants, and the like (hereinafter referred to as structures). In addition, various materials such as iron, resin, rubber, stone, concrete, wood, ceramic, glass, and the like are used for the material.

For example, there are various types of constructions related to social infrastructure, such as houses, collective housing, school buildings, stations, airport terminals, hospitals, government buildings in cities, towns and villages, bridges, tunnels, and the like. The shapes of these constructions are maintained by various structural materials such as columns, beams, floors, ceilings, bolts, nuts, and reinforced concrete. In addition, various members and equipment such as a glass window, a door, or the like are used without being limited to the structural materials, and the constructions are formed to have various shapes and structures with various materials.

The structural materials are premised on being used for a long period of time, but aging is inevitable because they are exposed to external forces caused by impacts such as thermal expansion and contraction due to cold and warm, deterioration with age, earthquake disasters, and the like. When aging is neglected, there is also a possibility that a disaster related to human life may occur.

In addition, disasters such as typhoons, tornadoes, earthquakes, and the like, which are expected to increase in magnitude in the future, apply excessive stress or load to a glass window, and thus cracks may occur or parts may fall out. When these are neglected, the glass window may be broken, and thus there is also a possibility of injury.

Therefore, in the future, it is possible to quantitatively and extensively monitor and perform maintenance on various members such as construction materials, and thus it is important to realize disaster reduction and disaster prevention (national resilience) by preventing accidents and disasters in advance.

In addition, according to a related art, a technology is proposed for capturing images of a defect on a concrete surface with a camera such as a hi-vision camera, and performing a defect inspection while viewing the images (for example, Patent Document 1).

In addition, a technology is proposed for capturing images of structures such as dams, buildings, overpasses, and the like by allowing a drone equipped with a camera to fly by remote control, and inspecting the structures using the captured images (for example, Patent Document 2).
Patent Document 1: Japanese Patent Application Laid-Open Publication No. 2005-30961
Patent Document 2: Japanese Patent Application Laid-Open Publication No. 2015-194069

### BRIEF SUMMARY

At present, when taking a construction as an example, there are a vast number of constructions, and it is practically impossible to give priority to construction materials on which maintenance is to be performed, or to determine a structural material on which maintenance is intensively to be performed in one construction.

In addition, when performing visual inspection or performing inspection with camera images, it is eventually necessary to go to a field. However, when it is necessary to continuously perform periodic inspection on a vast number of constructions, there is an issue of being quite difficult from a viewpoint of securing necessary human resources, time required for moving to a field or inspection, or involving a risk.

In addition, according to image capturing using a drone, it is possible to inspect a place that is not easily accessible by an operator. However, there are cases in which it is not possible to fly due to strong rain or wind, or to maintain a posture even when flying. In other words, there is a possibility that inspection using the drone is not available at all depending on the weather, and it is not possible to perform inspection only when the drone is flying. Accordingly, there is an issue of time available for inspection being limited.

The present disclosure has been made after earnest research in view of the above issues, and is intended to provide a means for enabling imaging of preset arbitrary places of various structures including constructions at all times or at a predetermined timing.

According to an aspect, there is provided an image-information-acquisition-type fastening member including a fastening body including a thread part mountable on a member, an imaging portion disposed integrally or as a separate body with respect to the fastening body, the imaging portion being configured to capture image information by imaging a surrounding, and a transmit portion configured to transmit the image information captured by the imaging portion to the outside.

In addition, the image-information-acquisition-type fastening member includes an analysis portion configured to perform analysis for detecting a detection target from an image captured by the imaging portion, and the transmit portion is configured to transmit information on the detection target detected by the analysis portion to the outside in conjunction with the image information.

In addition, the detection target is corrosion, damage, deformation, loosening of a fastening body, displacement, discoloration, deterioration, a stain, a dropout, a joint gap, an omission, clogging, and/or adhesion of a foreign substance.

In addition, the imaging portion includes a plurality of optical systems and imaging elements, and the image-information-acquisition-type fastening member includes an image processing portion configured to generate an omnidirectional image by synthesizing images captured by the respective imaging elements.

In addition, the fastening body includes a shaft portion having the thread part on an outer periphery thereof, and the imaging portion is disposed on an end surface of the shaft portion, and a shape of the imaging portion when viewed in an axial direction of the fastening body fits within a diameter of the shaft portion.

In addition, the fastening body includes a shaft portion having the thread part on an outer periphery thereof, and a head portion formed at one end of the shaft portion, and the imaging portion is disposed on a front surface of the head portion, and a shape of the imaging portion when viewed in an axial direction of the fastening body fits within an outline of the head portion.

In addition, the fastening body has a nut-shape, and the imaging portion is disposed on an end surface of the fastening body, and a shape of the imaging portion when viewed in an axial direction of the fastening body fits within an outline of the fastening body.

In addition, the image-information-acquisition-type fastening member includes a voice acquisition portion configured to acquire a surrounding voice, and the transmit portion is configured to transmit a voice acquired by the voice acquisition portion.

In addition, the image-information-acquisition-type fastening member includes a position information acquisition portion configured to acquire position information, and an orientation information acquisition portion configured to acquire orientation information, and the transmit portion is configured to transmit the position information and the orientation information.

In addition, the fastening body includes a thread part by which a plurality of members are fastenable to each other.

According to another aspect, there is provided a monitoring system including an image-information-acquisition-type fastening member including a fastening body having a thread part fixable to a member, an imaging portion disposed integrally or as a separate body with respect to the fastening body, the imaging portion configured to capture image information by imaging a surrounding, and a transmit portion configured to transmit the image information to the outside, and a monitoring device including a communication portion capable of communicating with the image-information-acquisition-type fastening member and configured to receive the image information, and an analysis portion configured to perform analysis for detecting a detection target from an image based on the image information.

In addition, the detection target is corrosion, damage, deformation, loosening of a fastening body, displacement, discoloration, deterioration, a stain, a dropping, a joint gap, an omission, clogging, and/or adhesion of a foreign substance.

In addition, the imaging portion includes a plurality of optical systems and imaging elements, and the image-information-acquisition-type fastening member includes an image processing portion configured to generate an omnidirectional image by synthesizing images captured by the respective imaging elements.

In addition, the fastening body includes a shaft portion having the thread part on an outer periphery thereof, and the imaging portion is disposed on an end surface of the shaft portion, and a shape of the imaging portion when viewed in an axial direction of the fastening body fits within a diameter of the shaft portion.

In addition, the fastening body includes a shaft portion having the thread part on an outer periphery thereof, and a head portion formed at one end of the shaft portion, and the imaging portion is disposed on a front surface of the head portion, and a shape of the imaging portion when viewed in an axial direction of the fastening body fits within an outline of the head portion.

In addition, the fastening body has a nut-shape, and the imaging portion is disposed on an end surface of the fastening body, and a shape of the imaging portion when viewed in an axial direction of the fastening body fits within an outline of the fastening body.

In addition, the image-information-acquisition-type fastening member includes a voice acquisition portion configured to acquire a surrounding voice, and the transmit portion is configured to transmit a voice acquired by the voice acquisition portion.

In addition, the image-information-acquisition-type fastening member includes a position information acquisition portion configured to acquire position information, and an orientation information acquisition portion configured to acquire orientation information, and the transmit portion is configured to transmit the position information and the orientation information.

In addition, the monitoring device includes a display portion configured to display the image information and/or detection target.

In addition, the monitoring device includes a notification portion configured to notify that the detection target is being detected.

In addition, the fastening body includes a thread part by which a plurality of members are fastenable to each other.

According to the present disclosure, by way of a simple structure, it is possible to image a preset arbitrary place of various structures including a construction at all times or at a predetermined timing.

### BRIEF DESCRIPTION OF THE DRAWINGS

FIG. 1 is a block diagram illustrating a monitoring system according to an example embodiment.

FIG. 2 is a diagram illustrating an external appearance of an image-information-acquisition-type fastening member according to an example embodiment.

FIG. 3 is a block diagram illustrating an imaging portion.

FIGS. 4A and 4B show a diagram illustrating an example of disposition of an imaging unit.

FIG. 5 is a diagram illustrating an example of disposition of an image-information-acquisition-type fastening member with respect to a construction.

FIGS. 6A-6D show a diagram illustrating an example of disposition of an imaging portion.

FIGS. 7A-7C show a diagram illustrating an example of disposition of an imaging portion.

FIG. 8 is a diagram illustrating a female thread part in which an imaging portion is provided.

FIG. 9 is a diagram illustrating an image-information-acquisition-type fastening member with a translucent cover disposed on a head portion.

### DETAILED DESCRIPTION

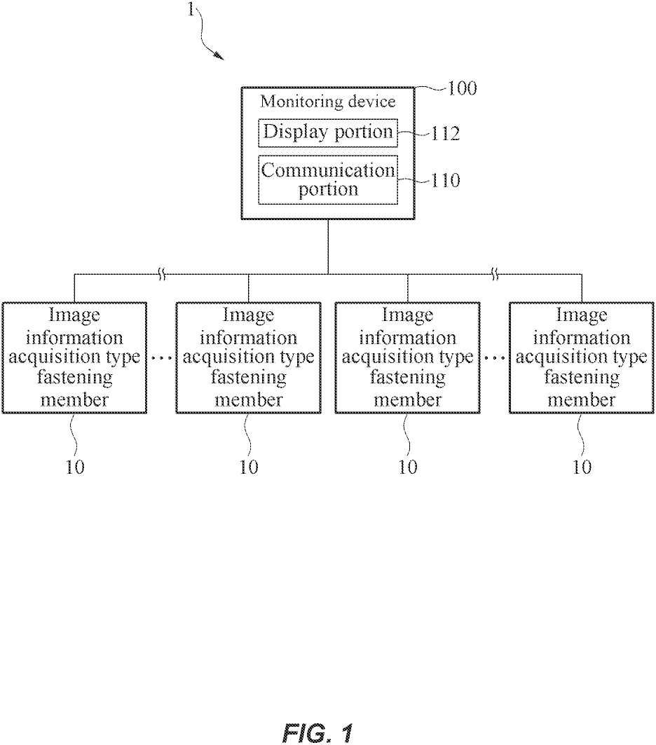

Hereinafter, an example embodiment of a monitoring system using an image-information-acquisition-type fastening member according to the present disclosure is described with reference to drawings. FIG. 1 is a block diagram illustrating a monitoring system 1 of an example embodiment. The monitoring system 1 includes a plurality of image-information-acquisition-type fastening members 10 and a monitoring device 100, and the image-information-acquisition-type fastening member 10 and the monitoring device 100 are communicatably connected to each other in a wired or wireless manner.

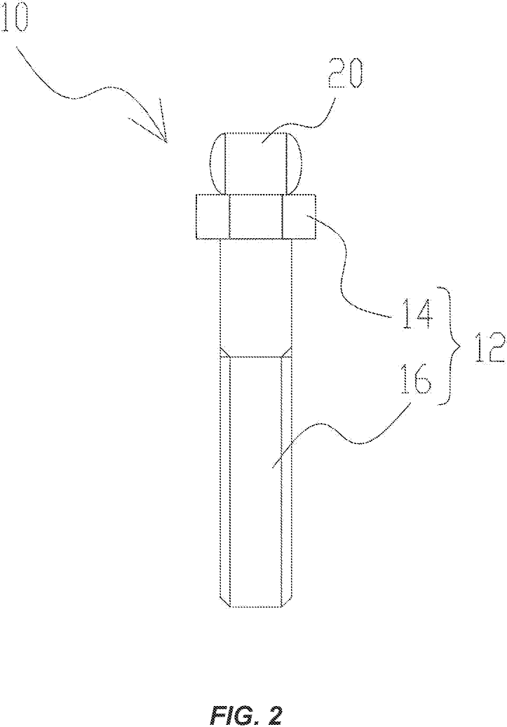

FIG. 2 is a diagram illustrating an external appearance of an image-information-acquisition-type fastening member according to an example embodiment. The image-information-acquisition-type fastening member 10 includes a fastening body 12, an imaging portion 20 capable of capturing a moving image and/or a static image. The fastening body 12 has a so-called bolt shape. For example, the fastening body 12 includes a head portion 14 having a hexagonal external shape, and a shaft portion 16 (thread part) provided with an external thread helical groove on at least a portion of an outer peripheral surface thereof.

The imaging portion 20 is a digital camera capable of imaging a monitoring target area mounted on the fastening body 12, and is an omnidirectional camera in this case, and captures an omnidirectional (360°) panoramic image. In addition, the imaging portion 20 has a size that does not protrude outward in a radial direction of the head portion 14. In other words, the imaging portion 20 has a shape that fits within an outline of an outer peripheral surface of the head portion 14 when viewed in an axial direction of the fastening body 12.

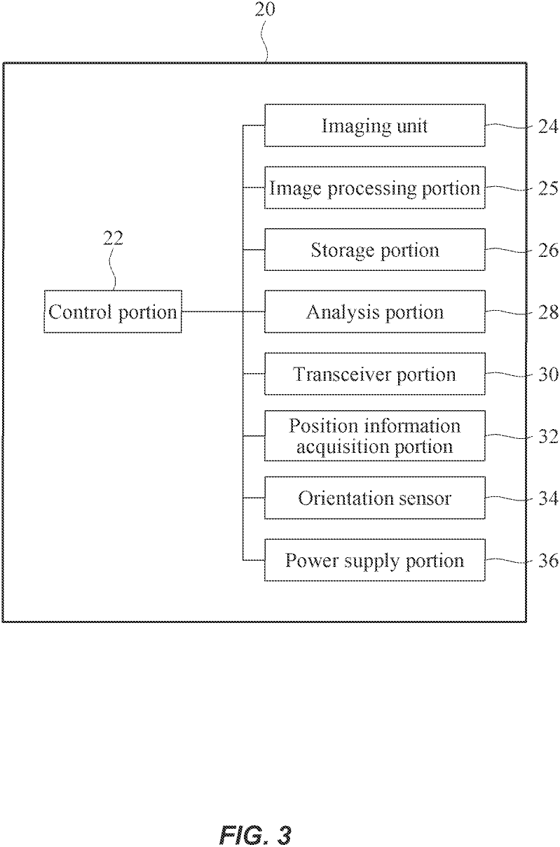

FIG. 3 is a block diagram illustrating the imaging portion 20. The imaging portion 20 includes a control portion 22 that comprehensively controls the operation of each portion. An imaging unit 24, an image processing portion 25, a storage portion 26, an analysis portion 28, a transceiver portion 30, a position information acquisition portion 32, an orientation sensor 34, a power supply portion 36 are connected to the control portion 22.

The imaging unit 24 includes an optical system including a fish-eye lens or an ultra-wide-angle lens, a zoom lens, and a focus lens, and an imaging element such as CCD or CMOS that generates an imaging signal based on subject light incident on an imaging surface. In addition, the imaging unit 24 is not limited to one imaging unit, but a plurality of imaging units may exist.

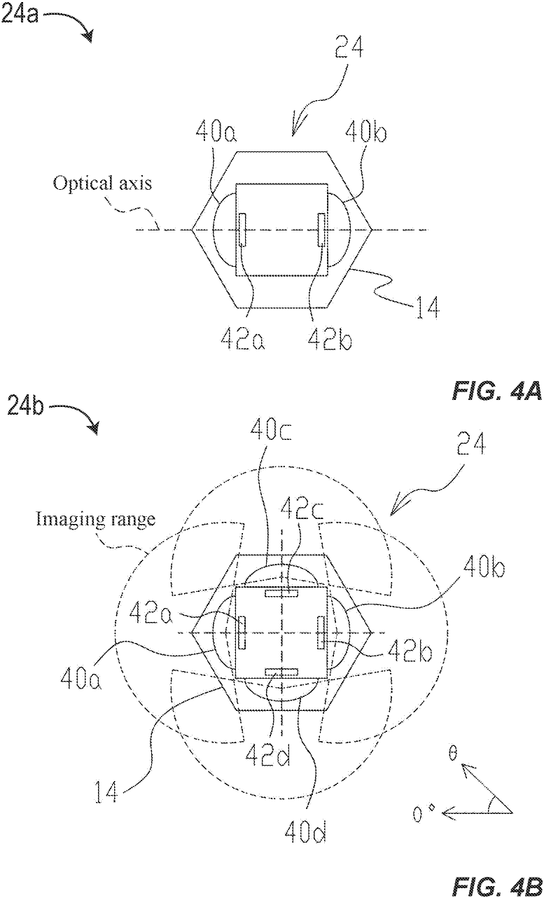

For example, when a viewing angle by the optical system is 180° or more, the imaging portion 20 includes two imaging units 24a and 24b, as illustrated in FIG. 4A. In other words, the imaging portion 20 includes the imaging unit 24a including an optical system 40a and an imaging element 42a, and the imaging unit 24b including an optical system 40b and an imaging element 42b. In addition, the imaging units 24a and 24b are disposed so that both optical axes of the respective optical systems 40a and 40b are aligned on the same straight line. Thus, among the imaging units 24a and 24b, a back side that is out of an imaging range of one unit is imagined by the other one, thereby enabling capturing of an omnidirectional panoramic image.

In addition, when the number of imaging units 24 is three or more, blind spots in the imaging range may be further eliminated. For example, within a surface parallel to a surface for fixing an imaging portion 20, the imaging portion 20 may be configured by disposing four imaging units toward different directions by 90 degrees each. Specifically, as illustrated in FIG. 4B, the imaging element 42a is disposed toward a direction of θ=0°, the imaging element 42b is disposed toward a direction of θ=180°, an imaging element 42c is disposed toward a direction of θ=90°, and an imaging element 42d is disposed toward a direction of θ=270°.

Thus, what is between the imaging elements 42a and 42b, and is out of both imaging ranges may be imaged with the imaging elements 42c and 42d, and what is between the imaging elements 42c and 42d, and is out of both imaging ranges may be imaged with the imaging elements 42a and 42b, thereby capturing a panoramic image without a blind spot.

In addition, the imaging portion 20 may be configured to further include a rotation mechanism that rotates the optical system and the imaging element, and an operation circuit capable of remotely operating the rotation mechanism. Thus, even when respective viewing angles by the optical systems 40a and 40b and the imaging elements 42a and 42b are less than 180°, the rotation mechanism is operated in accordance with an instruction received via the transceiver portion 30, and accordingly imaging in substantially all directions is possible.

The image processing portion 25 produces panoramic image data by performing various types of image processing on an imaging signal generated by an imaging element of the imaging unit 24. Specifically, the panoramic image data is produced by performing a synthesis process or the like for connecting image data based on respective imaging signals generated from a plurality of imaging elements. Of course, the image processing by the image processing portion 25 is not limited thereto, but includes known image processing such as A/D conversion processing, pixel interpolation processing, resizing processing, and color correction processing.

In addition to storing a unique ID of an image-information-acquisition-type fastening member 10, the storage portion 26 stores a processing result or the like of each portion. In addition, the storage portion 26 may store image data based on an imaging signal generated by each imaging unit 24, which is a basis of the panoramic image data.

The analysis portion 28 performs detection on a detection target existing in a monitoring target area (captured in the panoramic image) by image analysis, and the like. Here, the detection target is, for example, loosening, corrosion (rust and the like), damage (peeling-off, exfoliation, a defect, a crack, a wound, and the like (of painting)), contamination, deformation (curving, warping, bending, stretching, expansion including shrinkage, contraction, and the like), displacement (subsidence, movement, inclination, and the like), discoloration, deterioration, a stain, a dropout, a joint gap, an omission, clogging (such as soil and sand), adhesion of a foreign substance, being burned, being scorched, disappearance, and the like of a fastening body such as a bolt, nut, or the like including itself (fastening body 12) that is imprinted on the panoramic image. In addition, the foreign substance is moisture including a raindrop and snow, salt, a bird dropping, sand, dust, pollen, and the like, and may cause a burden on a member, or may be a cause of corrosion.

In a method of detecting the detection target, for example, a reference luminance may be set for each subject, and a place where luminance is changing with respect to the reference luminance may be detected as the detection target. In addition, in detection by a change in luminance, good image data cannot be obtained in a time period when the sun sets and there is little visible light compared to a time period such as during bright daytime. In addition, similarly, satisfactory image data may not be obtained even in a place that is a shaded area where sunlight hardly streams.

Therefore, an infrared light irradiating portion (not illustrated) is provided around the imaging portion 20, on a front surface and/or a peripheral surface of the head portion 14, and infrared light is irradiated when an amount of light is less. A state in which the infrared light is irradiated may be set to the reference luminance, and the detection target may be detected while irradiating the infrared light. In addition, by disposing a light emitting element instead of the infrared light irradiating portion, imaging may be performed by the imaging portion 20 while irradiating light from the light emitting element in the imaging range.

In addition, a well-known appearance inspection using image recognition AI technology by machine learning may be applied to perform inspection, analysis, abnormality detection, and the like of the detection target.

In addition, the analysis portion 28 may detect the detection target (loosening of the image-information-acquisition-type fastening member 10 itself) by detecting a difference between an image captured at a certain point in time and an image captured thereafter. Specifically, when loosening occurs in the fastening body 12, the imaging portion 20 rotates together with the fastening body 12 in a direction of loosening, and an optical axis of an optical system of the imaging unit 24 moves. Therefore, for example, an image captured at the time of fastening a member is stored as a reference image in the storage portion 26 in advance, and an image captured by the imaging portion 20 is compared with the reference image to detect a difference such as a position movement and the like of a subject in the image, thereby detecting loosening occurring in the fastening body 12 or calculating a loosening rotation angle.

Of course, performing difference detection by comparing images captured at a point in time and another point in time is not limited to the purpose of detecting loosening occurring in itself. For example, difference detection may be performed so as to detect loosening of another fastening body, and the like.

In addition, the analysis portion 28 may set a person or the like as the detection target. When the detection target moves, it may be tracked. When the detection target is a person, the detection target may be detected using a face detection or human body detection technology, or the detection target detected by position prediction or template matching may be tracked, for example.

The transceiver portion 30 performs transmission and reception of data to and from the monitoring device 100 via an antenna (not illustrated). For example, in addition to performing transmission of panoramic image data, reception of various types of information is performed. The position information acquisition portion 32 may register position information acquired in advance by any method, in addition to acquiring the position information by receiving a signal from an external source, such as a GPS satellite or wireless LAN. The orientation sensor 34 is provided with a terrestrial magnetism sensor or the like, and detects an orientation when the image-information-acquisition-type fastening member 10 is used as a reference. The power supply portion 36 performs supply of power required for operation of each portion. In addition, an external power supply (not illustrated) or a battery (not illustrated) for supplying power may be connected to the power supply portion 36. In addition, a power generating element capable of receiving various types of energy such as heat, light, vibration, pressure, and radio waves from the outside may be connected to supply necessary electric power.

The monitoring device 100 is an information processing terminal capable of receiving panoramic image data and displaying a panoramic image, and includes a communication portion 110 that performs transmission and reception of various types of data, a display portion 112 that displays a panoramic image of the received panoramic image data, and the like. The monitoring device 100 is, for example, a smartphone capable of displaying a panoramic image, a mobile phone (feature phone), a personal digital assistant (PDA), a wearable terminal (head-mounted display, glasses-type device, and the like), a tablet terminal, a notebook PC, a desktop PC, and other various computers, and a monitor having an arithmetic circuit. In addition, the monitoring device 100 may perform direct communication with the image-information-acquisition-type fastening member 10, but may perform transmission/reception of data via a transmission server or the like.

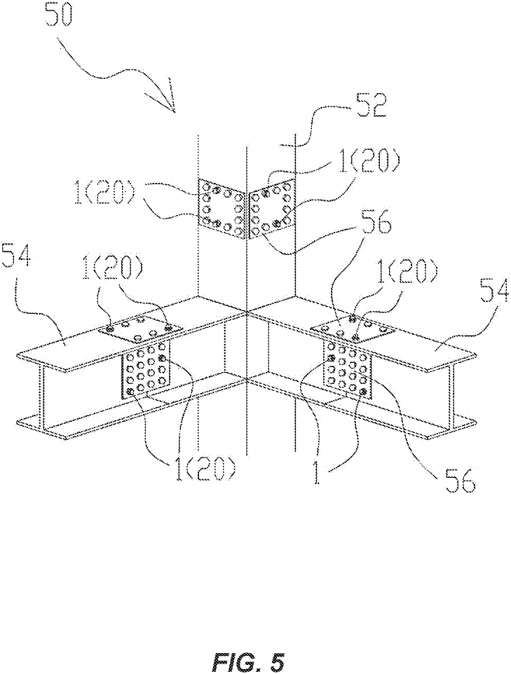

Next, application of the image-information-acquisition-type fastening member 10 to a structure is described. FIG. 5 is an enlarged view illustrating a construction to which the image-information-acquisition-type fastening member 10 is applied according to an example embodiment. The image-information-acquisition-type fastening member 10 may be applied as a thread fastening body that fastens to-be-fastened members that form a construction, for example. In addition, the image-information-acquisition-type fastening member 10 is disposed so that the imaging portion 20 is exposed when the members are fastened to each other.

Specifically, as illustrated in FIG. 5, the image-information-acquisition-type fastening member 10 that is a thread fastening member is fastened to a pillar 52 formed of a steel material of a square cylinder extending in a vertical direction of a construction 50, or a plurality of places of a joint portion that connects a beam 54 that is an H-shaped steel, a so-called H-steel, extending in a horizontal direction from the pillar 52, using a connection plate 56. The image-information-acquisition-type fastening member 10 is a portion to which a structural material (frame material) of the construction 50 is joined. In addition, the imaging portion 20 is exposed to the outside of the structural material so that a surrounding is imaged.

It is desirable that the plurality of image-information-acquisition-type fastening members 10 select places with different axial directions (directions of fastening). Thus, panoramic images with other various positions and directions may be acquired, and thus it is possible to perform monitoring while verifying a surface state of the construction 50 and a surrounding condition.

Next, a process of allowing the monitoring device 100 to display a panoramic image captured by the image-information-acquisition-type fastening member 10 is described. The image-information-acquisition-type fastening member 10 that fastens the structural material of the construction 50 performs imaging by the imaging portion 20. In other words, the control portion 22 performs imaging by the imaging portion 20 to acquire image data. The control portion 22 performs production of panoramic image data from the image data. Specifically, when the imaging portion 20 includes a plurality of imaging units 24, the control portion 22 synthesizes image data from each imaging unit 24 by the image processing portion 25 to produce panoramic image data.

The control portion 22 performs analysis processing on the panoramic image data by the analysis portion 28 to perform detection of a detection target. In the analysis processing, as described above, an appropriate detection method is performed, such as detecting a detection place from a change in luminance or detecting a detection place by face detection, human body detection, or the like.

In addition, the control portion 22 acquires each of position information by the position information acquisition portion 32 and orientation information that is a result of detection by the orientation sensor 34, and stores, in the storage portion 26, the panoramic image data, the detection target, the position information, and the orientation information in association with one another. The control portion 22 transmits, to the monitoring device 100, monitoring image information obtained by combining a unique ID, the panoramic image data, the detection target, the position information, and the orientation information stored in the storage portion 26 via the transceiver portion 30.

The monitoring device 100 displays, based on the received monitoring image information, a monitoring image on the display portion 112. In the monitoring image, in addition to the panoramic image, a capturing position based on the position information, orientation, detection target, and the like appear. In addition, in the monitoring image including the detection target, for example, a frame image that surrounds the detection target in the panoramic image is displayed in an overlapping manner. Specifically, with respect to one detection target, one frame is displayed so that the one detection target is placed within the frame, thereby displaying the detection target to be visually recognized. Therefore, when a plurality of detection targets exist, a plurality of frame images may be displayed, and the visual recognition of the detection object may be clearly performed.

Thus, by displaying the monitoring image on the display portion 112, it is possible to monitor a surrounding condition of the image-information-acquisition-type fastening member 10 provided in the construction, even from a remote location.

In addition, when the panoramic image is a moving image, the control portion 22 continuously performs the analysis processing by the analysis portion 28 while capturing the moving image to temporally transmit the monitoring image information to the monitoring device 100. The monitoring device 100 updates the monitoring image displayed on the display portion 112 whenever the monitoring image information is received.

As described above, the image-information-acquisition-type fastening member 10 is used for fastening members, and at the same time, images a surrounding by the imaging portion 20 to obtain a panoramic image, and thus a substantially arbitrary place may be monitored at all times with respect to a monitoring target such as a structure including a construction. In addition, analysis for detecting the detection target is performed from the panoramic image, and thus it is possible to easily verify loosening of a fastening body, corrosion of a member, damage, contamination, deformation, and displacement, adhesion of a foreign substance, and the like via the monitoring device 100. Accordingly, it is possible to reduce time and effort required for inspection of a structure and the like performed by a worker on site.

In addition, a detection target detected in a monitoring target area may be verified via the monitoring image displayed on the display portion 112 of the monitoring device 100. In addition, when the monitoring image, which is a moving image, is displayed, it is possible to verify a change or the like of the detection target over time.

In addition, in the above-described example embodiment, it is described that analysis of a panoramic image is performed by an analysis portion of an image-information-acquisition-type fastening member, but is not limited to thereto. A monitoring device may perform analysis of the panoramic image. Specifically, the analysis portion is provided in the monitoring device, and the monitoring device performs, by the analysis portion, analysis of the panoramic image data received from the image-information-acquisition-type fastening member to detect a detection target. Thus, a processing load by a control portion of an imaging portion is reduced, thereby improving a processing speed of an entire monitoring system.

In addition, the monitoring device 100 may perform image processing. In other words, the imaging portion 20 includes the imaging unit 24 and the transceiver portion 30, and the monitoring device includes an image processing portion and an analysis portion, thereby transmitting imaging data acquired by the imaging portion to the monitoring device. In addition, the monitoring device may perform analysis of the panoramic image data while producing the panoramic image data from the imaging data.

In addition, although it is described that the monitoring image displayed on the display portion 112 of the monitoring device 100 includes the panoramic image, only the detection target may be displayed. Even in such a manner, it is possible to verify that the detection target exists.

In addition, a server that manages data transmission/reception may be provided between the image-information-acquisition-type fastening member and the monitoring device, and the server may perform analysis processing to detect the detection target. In this case, the unique ID, panoramic image data, position information, and orientation information are transmitted from the image-information-acquisition-type fastening member to the server. In addition, the server produces monitoring image information in addition to received information on the detection target detected by analysis, and thus it is also possible to transmit the monitoring image information to the monitoring device.

With the monitoring system built by the image-information-acquisition-type fastening member, monitoring device, and server, loosening of the fastening body, corrosion of a member, damage, contamination, deformation, displacement, adhesion of a foreign substance, and the like may be easily verified via the monitoring device. Therefore, it is possible to reduce time and effort required for the inspection of a structure and the like performed by a worker on site. In addition, a management server performs analysis processing, thereby improving a processing speed of an entire monitoring system.

In addition, the image-information-acquisition-type fastening member 10 may be provided with a voice acquisition portion having a microphone and the like for acquiring a surrounding voice. In this case, it is possible to verify abnormality, such as an abnormal noise that is not reflected in an image, by performing voice acquisition while performing imaging.

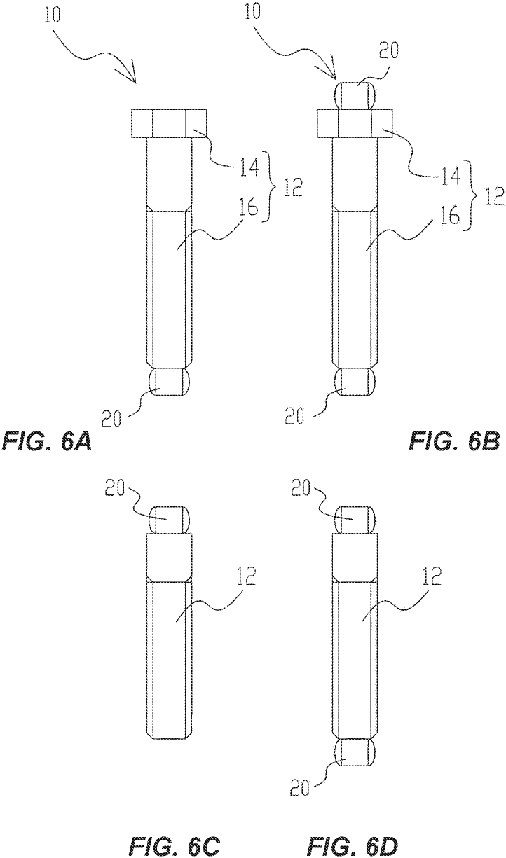

In addition, the above-described imaging portion 20 is described as being provided on a front surface of the head portion 14, but it is not limited thereto. As illustrated in FIG. 6A, the imaging portion 20 may be provided on a distal end side of the shaft portion 16. As illustrated in FIG. 6B, the imaging portion 20 may be provided on a front surface of the head portion 14 and each of both ends of a distal end surface of the shaft portion 16.

In addition, the image-information-acquisition-type fastening member 10 may have the fastening body 12 only of a shaft portion without a head portion. As illustrated in FIG. 6C, the imaging portion 20 may be disposed on one end surface of the fastening body 12. As illustrated in FIG. 6D, the imaging portion 20 may be disposed on each of both end surfaces of the fastening body 12. In addition, in this case, the imaging portion 20 sets a shape and size so as to fall within an outline formed by a trough of a male thread of the shaft portion 16 when viewed from an axial direction.

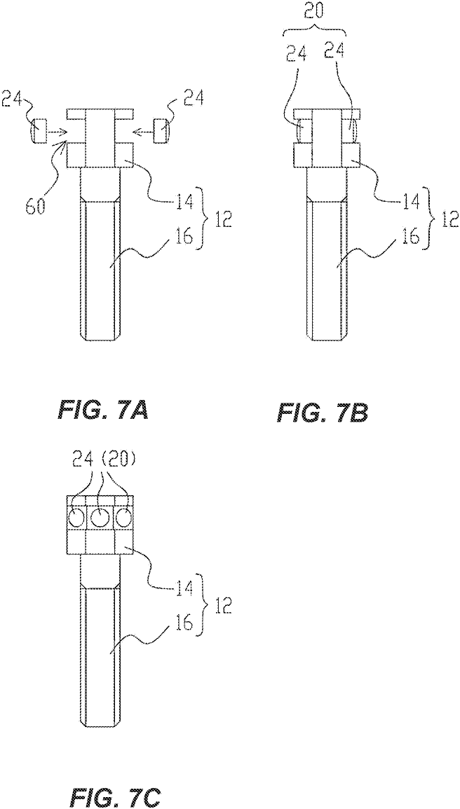

Of course, the imaging portion 20 may be provided on a side surface of the head portion 14 (or the shaft portion 16). For example, as illustrated in FIG. 7A, the imaging portion 20 may be configured by forming one or a plurality of grooves 60 in which a peripheral surface is concave in a radial direction, and disposing the imaging unit 24 in the groove 60. The imaging unit 24 is configured by disposing a plurality of imaging units 24 at predetermined intervals in a peripheral direction, as illustrated in FIGS. 7B and 7C. In addition, a depth of the groove 60 is set so that the imaging unit 24 does not protrude outside the peripheral surface of the head portion 14. In addition, in order to supply power to the imaging portion 20, a hole along a central axis of the head portion 14 and through which a part of the groove 60 is drillable is provided on a front surface of the head portion 14, a power supply and the imaging portion 20 may be connected to each other through the hole.

In addition, a monitoring target area imaged by the imaging portion 20 is not limited to all directions, but may be appropriately set.

In addition, the imaging portion 20 is provided with an accessory shoe, and a shoe mounting portion is provided on an end surface of the head portion 14 or the shaft portion 16 of the fastening body 12, so that the accessory shoe is inserted into the shoe mounting portion, thereby allowing the imaging portion 20 to be held detachably with respect to the fastening body 12.

When the imaging portion 20 is detachable, the fastening body 12 may be clamped by separating the imaging portion 20 when the fastening body 12 is clamped to a member to be fastened, and then the imaging portion 20 may be mounted, and thus there is no concern that a fixing tool or the like comes into contact with the imaging portion 20, thereby improving fixing workability.

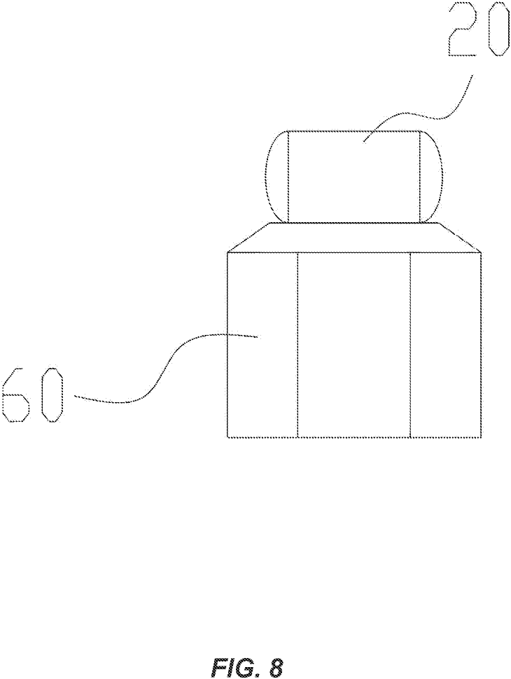

In addition, it is described that the image-information-acquisition-type fastening member has a bolt-shaped fastening body. However, a nut-shaped fastening body may be provided with an imaging portion. In other words, the imaging portion 20 may be disposed on one closed end surface of a female thread part 60 having an envelope nut shape illustrated in FIG. 8. Even in this case, a shape or size of the imaging portion 20 is set to fit within an outer peripheral portion of the female thread part 60 when viewed from the axial direction.

In addition, the imaging portion may be provided on a washer-shaped fastening body. In other words, it is possible to dispose the imaging portion on an end surface or peripheral surface of a washer.

In addition, the imaging portion may perform imaging according to an instruction received through the transceiver portion, and may perform, based on the instruction, transmission of the panoramic image data stored in the storage portion. Thus, an image may be captured or transmitted at a desired timing by a remote instruction via the monitoring device.

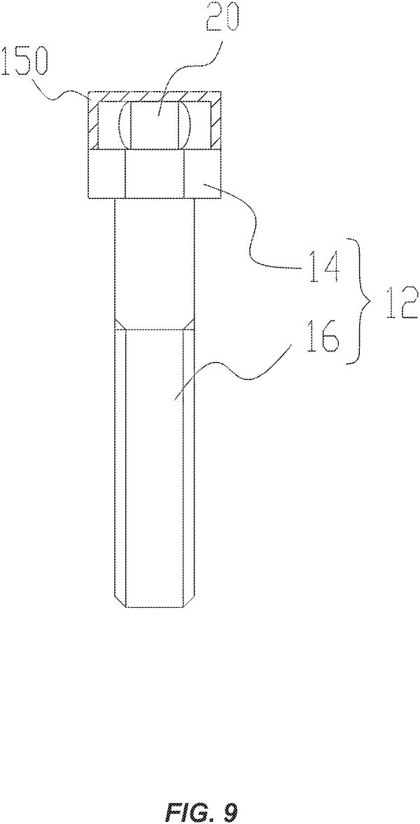

In addition, when the imaging portion 20 is provided on a front surface of a head portion, a translucent cover that surrounds the imaging portion 20 may be disposed. Here, FIG. 9 is diagram illustrating the image-information-acquisition-type fastening member 10 with a translucent cover 150 disposed on the head portion 14. The translucent cover 150 has a closed cross-sectional structure including a closed space, and surrounds the imaging portion 20 by the closed space. In other words, as illustrated in FIG. 9, the translucent cover 150 has a substantially cup shape, and an opening of the cup is fit to the head portion 14, and thus the imaging portion 20 may be positioned in an inner space of the cup, and as a result, the imaging portion 20 may be surrounded. As described above, the translucent cover 150 may be appropriately set as long as it has a shape capable of surrounding the imaging portion 20, and may have a substantially dome shape, a substantially cylindrical shape, a substantially cone shape, or the like, for example.

In addition, the translucent cover 150 may be formed of glass, a polymer compound, or the like. The glass may include one or more of soda glass, quartz, sapphire, ruby, tempered glass, and lead glass.

The polymer compound includes one or more of fluorine, polyester, polycarbonate, polyethylene terephthalate, polybutylene terephthalates, acrylic, polyether, vinyl, urethane, polyamide, and epoxy.

In addition, when the translucent cover 150 and the head portion 14 are sealed by a method of screwing an end of the head portion 14 and an end of the translucent cover 150 together, it is possible to improve the dustproofness and waterproofness of the imaging portion 20. In other words, it is possible to prevent intrusion of foreign substances such as liquid or fine dust from between the head portion 14 and the light-transmitting cover 150. Accordingly, it is possible to improve a degree of freedom of a disposition place of the image-information-acquisition-type fastening member 10.

In addition, the translucent cover 150 not only may surround the imaging portion 20, but also may have an antenna pattern on a surface thereof. In this case, the antenna pattern is a non-powered element having an endless shape, and is formed so as to couple the imaging portion 20 and an electromagnetic field to each other. Thus, the imaging portion 20 may perform transmission and reception of data via the antenna pattern. In other words, in transmission/reception processing performed by the transceiver portion 30, reception processing via the antenna pattern or transmission processing using directivity of the antenna pattern may be performed.

In addition, the antenna pattern may be formed by a conductive layer of a metal material mainly including at least one of TiO, TiN, ITO, FTO, graphene, tin oxide, zinc oxide, indium tin oxide, and the like. Formation of the antenna pattern includes, for example, a method of patterning a metal material according to a photo lithography method or an etching method, or a method of forming a conductive paste by screen printing.

In addition, the translucent cover 150 may be provided with a function of a half mirror. In other words, when a part of incident light from the outside is reflected, it is possible to suppress occurrence of halation in an image captured by the imaging portion 20, which becomes blurry. Accordingly, precision of detection of a detection target performed based on the captured image may be improved.

In addition, it is possible to make it difficult to visually recognize the imaging portion 20 inside the translucent cover 150 from the outside. In addition, when a part of incident light from the outside is reflected, it is possible to suppress, for example, light deterioration of a resin material, a metal, and the like existing in the translucent cover 150.

In addition, a filter (for example, an infrared transmitting filter, an ultraviolet transmitting filter, or the like) that selectively transmits or blocks light with a specific wavelength may be provided in the translucent cover 150 or the imaging portion 20.

In addition, the image-information-acquisition-type fastening member 10 or the monitoring device 100 may have a determination portion that determines a condition of the detection target. The determination portion may perform determination based on a preset determination criterion, but may improve accuracy of determination processing by learning processing using machine learning.

In addition, the condition of the detection target is, for example, a condition of damage, progress of abnormality in the detection target over time, and the like. In addition, a determination classification may be set as follows, for example:

Determination classification A: It is required to perform maintenance or the like when a detection target is not recognizable or is slightly abnormal.

Determination classification B: Depending on the situation, it is required to perform a repair.

Determination classification C: From a viewpoint of preventive maintenance, it is required to promptly perform a repair or the like.

Determination classification D: From a viewpoint of safety, it is required to perform promptly a repair or the like.

Determination classification E: From a viewpoint of safety, emergency response is required.

Determination classification F: In addition, urgent response is necessary.

Determination classification G: It is required to respond with maintenance work.

Determination classification H: A detailed investigation is required.

Determination classification I: A follow-up survey is required.

When each of the determination classifications is set as described above, the monitoring device 100 may perform a notification operation according to a determination result. Specifically, in the case of a determination classification other than determination classification A, it is informed that it is required to perform emergency response, maintenance work response, detailed investigation response, follow-up response, such as maintenance. As a notification method, for example, the display portion 112 displays the determination classifications, and displays a corresponding content according to a corresponding classification. In addition, it is also possible to notify by audio output or the like from a speaker (not illustrated).

Of course, it goes without saying that the monitoring device 100 may simply notify that a detection target exists, regardless of whether or not determination is performed.

In addition, in the above-described embodiment, a structure using the image-information-acquisition-type fastening member 10 is not specifically limited, various objects (a vehicle, a construction, and the like), an apparatus (a home appliance, and the like), a machine (an agricultural machine, a construction machine, a special construction machine, and the like) may also be included. For example, the vehicles include a manned movement or an unmanned movement, and include a multi-wheeled vehicle and a no-wheeled vehicle to be used on land. A multi-wheeled vehicle with four or more wheels include a truck, a bus, a fire truck, a ladder truck, a pump truck, a trailer, a tank lorry, a mixer vehicle, a crane car, a road surface sweeper, a vacuum car, a tow truck, a snowplow, a tramcar, a monorail, Shinkansen, a streetcar, a locomotive, a cable car, an armored vehicle, a tank, and the like, a four-wheeled vehicle includes a car, a police car, an ambulance, a camper, and the like, a three-wheeled vehicle includes a three-wheeled car and an automatic three-wheeled car, a two-wheeled vehicle includes a motorcycle, a scooter, a bicycle, an electric assist bicycle, a wheelchair, a stroller, a rickshaw, and the like, and a one-wheeled vehicle includes a one-wheeled car. A wheelless vehicle includes a linear motor car, a hovercraft, an elevator, an escalator, lift, a gondola, a ropeway, Ferris wheel, a merry-go-round, a swing, a seesaw, and the like. Other wheeled vehicles include a wheel loader, a tire roller, a road roller, a grader, an asphalt finisher, a motor sweeper, a dump car, a wheel crane, a forklift, a straddle carrier, a turret type premises transport vehicle, an agricultural tractor, an agricultural chemical spreading vehicle, a harvest threshing vehicle, a rice planting machine, a combine, a shovel car, a backhoe, a loading shovel, a snow mobile, a roller skate, roller shoes, a skateboard, a kickboard, a ski, a snowboard, skate shoes and the like. A flight vehicle or a moving object includes, regardless of a manned flight or an unmanned flight, a light aircraft such as a balloon or an airship, and a heavy aircraft such as an airplane, a rotary wing airplane, a glider, a helicopter, a drone, a rocket, a vertical takeoff and landing machine, and the like. A marine vehicle includes a ship, a boat, a yacht, a ferry, a passenger ship, a cargo-passenger ship, a cargo ship, an oil tanker, a fishing boat, a warship, a submarine, and the like. In addition, components used for the vehicle include a monocoque, a body shell, a bonnet, a door, a tailgate, a front fender, a radiator grill, a bumper, a meter, a heater, a windshield glass, a door window glass, an engine, a radiator, a muffler, a brake pedal, an accelerator pedal, a clutch pedal, a seat, an exhaust pipe, a tail lamp, a headlamp, a wheel, a tire, a track, a propeller, a tank, a cylinder, a piston, an actuator, a damper, a linear guide, a bearing, a chassis, a shaft, and the like.

The construction includes a structure and a civil engineering construction (workpiece). The structure includes housing, a commercial facility, a public facility, a cultural facility, an educational facility, a medical facility, an entertainment facility, a transportation facility, an industrial facility, a religious facility, a military facility, and a plant facility. The structure also includes a detached house, an attached house (terrace house), an apartment, a multi-unit dwelling, a share house, an office building, a church, a monastery, a temple, a shrine, a castle, a palace, an imperial palace, a garden, a park, a hospital, a clinic, a station, a station building, an airport, a public lodging house, a public office building, a police station, a fire station, a precinct station, a stadium, a ballpark, a schoolyard, a swimming pool, a school, a gymnasium, a theater, a cinema, a performance hall, an art center, a concert hall, a public hall, an meeting hall, a hotel, an inn, a factory, a storehouse, a warehouse, a boarding house, a dormitory, a child welfare facility, a midwifery office, a disabled person rehabilitation support facility, a mentally disabled person social rehabilitation facility, a protection facility, a women’s protection facility, an intellectually handicapped person support facility, a senior citizen welfare facility, a pay nursing home, a special support nursing home, a day service center, a maternal and child health facility, a cinema, a museum, an art gallery, a library, a public restroom, a sport practice ground, a bowling alley, a sky resort, a department, a supermarket, a general store, an exhibition hall, a cabaret, a café, a nightclub, a bar, a dancing hall, a playground, a public bathhouse, a waiting room, a restaurant, a bistro, a shop, a garage, a car repair shop, a movie studio, and a television studio.

The civil engineering construction (workpiece) includes a bridge, a metal structure, a railroad, a road, a harbor, a coast, a river, a power generation facility or generating unit, a dam, a tunnel, a land improvement construction, a disaster prevention construction, and an agricultural civil engineering construction. The bridge includes a girder bridge, a cable-stayed bridge, a truss bridge, an arch bridge, a rigid frame bridge, and a suspension bridge. The metal structure includes a tower-like structure, a storage structure, a sluice/floodgate, a hydraulic iron pipe, a composite structure, a water supply facility, sewerage, and various types of pipelines including an object to be delivered such as gas or petroleum. The railroad includes a track, a track structure, a roadbed, a railroad station, a signaling/security/communication facility, a highspeed railway, a special railway, a cableway, and a city railroad. The road includes a roadbed, a pavement, an asphalt pavement, a concrete pavement, a gravel road, and a dustproof road. The harbor includes an anchorage, a breakwater, a revetment, a jetty, a wharf, a quay, a pier, a shed, a cargo handling/land facility, a ship and car communication facility, a fishing port, and a navigation aid. The coast includes a coastal structure. The river includes an embankment/revetment, a sand arrestation, a river structure, and a canal. The power generation facility or generating unit includes a water intake facility, a reservoir, a regulating reservoir, a nuclear power plant, a thermal power plant, a hydroelectric power plant, a tidal power generation, a geothermal power generation, a wave power generation, and a wind power generation. The dam includes a gravity dam, a fill-type dam, and an arch dam. The tunnel includes a tunnel structure. The land improvement construction includes a land formation, a reclamation, a dredging, an irrigation, a drainage, a reclamation, and mixing of soils.

In addition, members used for the construction include stone including natural stone, artificial stone, and crushed stone, wood, a precut material, natural wood, machine grade wood, visual grade wood, ungraded wood, a class-A structural material, a class-B structural material, laminated wood, engineering wood, structural laminated wood, plywood, a wooden product, a resin product, a steel product, a steel material, a steel sheet, a steel frame, an organic material, a coating material, a waterproof material, a cement paste, slag, mortar, concrete, a tile, a porcelain tile, a stoneware tile, a pottery tile, a tatami mat, lightweight aerated concrete, a concrete panel, water resistant plywood, a gypsum board, a fireproof board, a calcium silicate board, a thermal insulation material, glass wool, rock wool, rigid urethane foam, Styrofoam, phenol foam, polystyrene foam, cellulose fiber, prestressed concrete, precast concrete, underwater concrete, polymer concrete, resin concrete, mass concrete, expanded concrete, low shrinkage concrete, and shrinkage-free concrete.

Parts of the construction include a structural material, a fastening member, a finishing material, a groundsill, an interior material, an exterior material, a facing material, a thermal insulation material, a base, a foundation, a wall, a pillar (column), a tubular column, a corner post, a splash post, a major pillar, a roof beam, a dragon beam, a round beam, an ascending beam, a roof, a ceiling, a floor, stairs, a puncheon, a vertical roof puncheon, a window, window glass, a window frame, a door, a door frame, a front door, a shelf, a baseboard, a doorcase, an upper frame of doorcase, a decorative pillar, an alcove, a decorated rail of alcove, a floor board of alcove, an alcove post, a transom, a lintel, an attached lintel, a girth, a dragon beam, a braced frame, a crosspiece, a stud, a puncheon, an eaves, an eaves soffit, a ceiling joist, an awning, a gutter, a flooring, a carpet, a cushion floor, cloth, wallpaper, a sliding door, door paper, a siding, an expansion joint, a roof tile, a cement roof tile, a slate roof tile, a colonial, a corrugated steel plate, and a handrail.

A structure that implements each member of the construction includes stone masonry, a brick structure, a wooden structure, a wood structure, a soil structure, a steel structure (S structure), a light gauge steel (LGS) structure, a heavy steel structure, a plain concrete structure, a reinforced concrete (RC) structure, a steel frame reinforced concrete (SRC) structure, a concrete filled steel tube structure, a cement block (CB) structure, a reinforced CB structure, a steel concrete composite structure, a prestressed concrete (PC) structure, a membrane structure, a wall structure, a frame structure, a masonry structure, a pneumatic structure (single-layer film), a pneumatic structure (dual-layer film), a pneumatic structure (air beam), a pure rigid frame structure, a walled rigid frame, a streaked rigid frame, a brace structure, a core structure, a tube structure, a truss structure, a bolt structure, a shell structure, a cable (hanging) structure, a pin structure, a space frame, an arch, a dome shell, an earthquake resistant structure, a base isolation structure, a vibration damping structure, a rigid structure, a flexible structure, and an earthquake-proof structure.

The home appliances include video equipment (displaying device) such as a television or a projector, video equipment (recording/replaying device) such as a video tape recorder, a digital video disc (DVD) recorder, a Blu-ray disc recorder, a hard disk drive (HDD) recorder, a DVD player or a Blu-ray disc player, video equipment (capturing device) such as a video camera or a digital camera, acoustic equipment (recording/replaying device) such as a wire recorder, a tape recorder, a minidisc recorder, a radio cassette player or an IC recorder, acoustic equipment (replaying device) such as an analog player, a compact disk (CD) player, an amplifier or a radio, acoustic equipment (reproducing device) such as a speaker or a headphone, white goods (refrigerator and washing machine), and information appliances.

The agricultural machine includes a general purpose agricultural machine such as a tractor, an agricultural machine used for cultivation/soil preparation such as a plough, a harrow, a roller, a rotary cultivator, a puddling machine, a land roller, a leveler, a ridger or a slitting machine, an agricultural machine used for cultivation/formation/improvement such as a rooting machine, a pan breaker, a grooving machine, a mold rina (culvert drilling machine), a digger or a backhoe, a machine used for fertilization such as a manure spreader (compost fertilizer distributor), a slurry spreader, a lime sower (lime distributor), a planter (seeder) or a drill seeder with fertilizer, an agricultural machine used for sowing/transplanting such as a rice transplanter, a vegetable transplanter, a transplanter (transplanting machine) or a broadcaster, an agricultural machine used for control and management such as a sprayer a motor sprayer, a mist machine, a duster, a motor duster, a granule applicator, a motor granule applicator, a haze machine, an aerial sprayer/helicopter (air control), a soil sterilizer, a brush cutter, a farm master, a speed sprayer, a frost damage protection machine, a medium cultivating and weeding machine, a thinner (thinning machine), a motor pump or a sprinkler (irrigator), an agricultural machine used for harvest such as a binder, a combine, a vegetable reaping machine, a mower, a hay baler, a roll baler, a windrower, a thresher, a bean cutter (bean harvester), a corn harvester, a corn sheller, a potato harvester, a beet harvester, a sweet potato digging machine, a sweet potato vine cutter, a sugarcane harvester, a peanut harvester, a flax harvester, an onion digging machine, a chestnut thresher, a peanut thresher, a plucker, a mulberry shoot reaping machine, a special purpose crop digging machine, a vibrating harvester or a hop flower thinning machine, an agricultural machine used for drying and preparing crops such as a drying machine, a rice harvester (rice huller), a sorting machine, a rice milling machine, a grass dryer, a chicken droplet dryer, a special purpose crop dryer, a grain milling machine, a disc mower, a mower conditioner, a tedder, a rake, a forage harvester, a hay baler, a hay press, a road wagon, a hay loader, a bale loader, a feed cutter, a forage blower, a silage unloader, a feed grinder, a feed chopper, a root cutter, a feed compounder or a feed molding machine, an agricultural machine used for managing livestock such as an automatic feeder, a milker, a milk cooler, a waterer, a water heater, a slurry spreader, a barn cleaner, a sludge separator, an excretion processing device, a warmer, an egg lifter, a sorting machine for cleaned eggs or a barn sterilizer, an agricultural machine used for rearing silkworms such as a young silkworm co-rearing temperature control device, a power mulberry feeder, an automatic rearing machine for young silkworms, an automatic rearing machine for grown silkworms, a delimbing machine, a cocoon harvesting machine or a floss removing machine, an agricultural machine used for vegetable/fruit growing such as a mulcher, a crucific cultivating machine, a house heater, a vegetable washer, a deep placement fertilizer applicator, a motor trimmer, a tree tower, a rotary cutter for orchard, a fruit sorting machine, a container in arboricultural land or a power tiller, an agricultural machine used for tea production such as a tea steaming machine, a primary drying tea roller, a freshly-picked-tea-leaves rolling machine, a secondary drying tea roller or a final drying tea roller, an agricultural machine used for flowering/special purpose crop such as a pruning machine, a ramie peeler, a rush classifier, a tulip classifier or a peanut peeler, an agricultural machine used for forestry such as a bush cutter, a chain saw or a yarder, and an agricultural machine used for transporting/conveyance such as a trailer, a grain conveyor or a front loader.

The general construction machine includes a bulldozer/scraper such as a bulldozer, a ripper bulldozer (bulldozer with rip saw), a scraper bulldozer, a towed scraper or a motor scraper, a backhoe/mucking shovel such as a hydraulic shovel (Yumbo), a backhoe, a power shovel, a dragline, a clamshell, an on-mud excavator, a tractor shovel, a wheel loader, a trencher or a bucket wheel excavator, a conveying machine such as a truck, a dump truck, a truck with a crane device, a trailer, a locomotive, a muck car, a shuttle car, a rough terrain hauler (special equipment hauler), a shovel loader, a fork loader, an all-wheel drive vehicle, a belt conveyor or a bucket wheel excavator, a crane/unloading machine such as a crawler crane, a truck crane, a wheel crane (all terrain crane), a rough terrain crane, a tower crane, a jib crane, a railroad crane, a floating crane, a pipe layer, a construction lift, an elevator, a portal crane, a fork lift, a straddle carrier, a container carrier, a top lifter, a clamp lift, an aerial vehicle (lift vehicle), a concrete floor finishing robot, a slinging excluding robot or an unloader, a foundation work machine such as a pile driver, a diesel hammer, a hydraulic hammer, a vibratory hammer, a water jet (water jet cutter), an earth auger, an inner excavator of earth auger, a drop hammer, a hydraulic steel pipe press-in and drawing machine, a sand pile driver, a powder injection agitator, an all casing backhoe, a hole digging and pole standing car, an earth drill, a reverse circulation drill, an underground continuous wall construction machine, a mud wastewater treatment facility (alkaline water neutralizer), a sludge suction and discharge vehicle (including vacuum car), a grout pump, a grout mixer (including mortar plant), pneumatic caisson construction equipment, a deep mixing processing machine, a ground improvement machine for high pressure injection stirring, chemical liquid injection and construction equipment, a caisson pile machine (rotary sprayer or underwater cutter) or a pile extractor, a perforator/tunnel construction machine such as a boring machine, a down-the-hole hammer, a rock borer (hand hammer, leg hammer, drifter, pick hammer, baby hammer, riveting hammer, chipping hammer, caulking hammer, scaling hammer, sand rammer, concrete breaker or large breaker), a drill jumbo, a crawler drill, a tunnel backhoe/cutter, a grab hopper, a grab lifter, tunnel construction equipment or shield construction equipment, a motor grader/sub-basics machine such as a motor grader, a stabilizer, a mixing plant or a mixing machine for super soft ground, compacting equipment such as a road roller (macadam roller or tandem roller), a tire roller, a tamping roller, a vibrating roller, a tamper, a rammer or a vibrating compactor, a concrete plant, a truck mixer (agitator body truck), a concrete pump car, a concrete pump, a concrete presser, a screw cleat, an agitator car or a concrete crusher, a paving machine such as an asphalt plant, a recycle plant, an asphalt finisher, an asphalt kettle, a distributor, a chip spreader, an asphalt cooker, a concrete spreader, a concrete finisher, a concrete leveler (concrete vertical finishing machine), a concrete simple finishing machine, a concrete lateral yarding machine, a vibrating joint cutting machine, a concrete cutter, an inner vibrator, an asphalt engine sprayer, an asphalt curbing machine, a joint sealer, a play susceptor, slip form paper or food preservation treatment machine, a pavement maintaining machine such as a road heater, a joint cleaner, a road cleaning car, a line maker, a dissolving tank, a lane marker removal machine, a road surface cutting machine, a road surface layer regenerating machine, a guardrail cleaning car, a road surface safety groove cutting machine (grooving machine), a sprinkler truck, a guardrail pole drive machine, a compartment line construction machine, a slab upper surface thickening machine, a micro surface machine or a drainage pavement function recovery machine, an air compressor/air blower such as an air compressor (pressure) or an air blower (fan), a pump such as a small spiral pump, a small multistage centrifugal pump (turbine pump), a underwater motor pump for deep well, a vacuum pump, an underwater motor pump for construction (diving pump), an underwater sand pump (underwater pump for construction with stirring device) or a slurry pump, an electric device such as a transformer, a switch in high pressure air, a cubicle type high-voltage substation facility or a motor generator, a winch such as a winch, a hoist or a chain block, test measurement equipment such as a track scale, a gauge, a core collector (core boring machine), a California bearing ratio (CBR) tester, a flat loading test apparatus, a grout flux/pressure measuring device, a gas detector, a noise meter, vibration measuring equipment, settling/inclination measuring equipment, a dust monitor, a nephelometer, an automatic surveying instrument or a light wave measuring device, a temporary facilities apparatus for installing a steel bridge/PC bridge such as an erected girder, a vent, a door type crane, a hoist, a chain block, a geared trolley, a winch, a jack, a hydraulic pump, a bogie for heavy weight, a delivery device, an steel tower, a carrier, a saddle, a back stay adjusting device, a cable anchoring device, a turn buckle, a rope hanger, an unreeler, a delivery device, a lateral yarding machine, a falling device, a traveler crane, a girder hanging device, a girder hanging gate preparation moving device, a turn table, a moving timber or a working car of ground cover and handrail, and other general land construction machines such as a concrete mixer, an aggregate measuring instrument, a concrete bucket, a concrete vibrator, a concrete crusher, a jaw crusher, an impact crusher, a welder, a welding rod dryer, a hydraulic jack, a drop hammer, a rail, a turn table, a mortar concrete spray machine, a concrete spray machine, an accelerating agent supply device, a seed spray machine, a Bentonite mixer, a water tank, a bush cutter, a lawn mower, a chain saw, a float, a construction signal, a construction high pressure washer, a chemical applicator, a hay collector, a jet heater, a garbage truck, a self-propelled crusher, a self-propelled soil improver or a self-propelled wood crusher.

In addition, the present disclosure is also applicable to a special construction machine, and the special construction machine includes a harbor/river/coast construction machine such as a main working ship, an auxiliary working ship, an auxiliary facility for working ship or auxiliary equipment for harbor construction, a dam construction machine such as a concrete production facility, a concrete conveyance facility, a concrete cooling facility, an aggregate production facility, a cement conveyance/storage facility, a watering facility, a pollution prevention facility or other dam construction machines, a snow removal machine such as a snowmobile, a snow removal device, a snow removal attachment or a salt truck, a sewerage construction machine such as a propulsion construction machine, and a mine clearing machine.

The machine tool includes a lathe such as a general purpose or NC turret lathe, a milling machine using a milling cutter or an end mill, a shaping machine using a bite, a planing machine using a bite, a drilling machine using a drill, a reamer or a tap, a boring machine using a bite, an electric discharge machine such as a wire cut electric discharge machine or an engraving electric discharge machine, a broaching machine using a broach, a gear hobbing machine (hob), a gear cutting machine such as a gear shaper (rack cutter or pinion cutter), a grinder using whetstone, a contour machine, a band sawing machine, a machining center, a water jet processor, a laser processor, an electronic beam processor, a honing machine, an electrochemical machine, a deburring chamfering machine, an electrochemical deburring machining, a cutting machine, a forging machine, and a forming device such as a nut former or a part former. In addition, the machine tool also includes various types of machining tools such as a drill, an end mill, a bite, a tip, a tap, toothed tools, a die, a mold, and the like, and a tool holder.

In addition, general purposes of the member include a structural material of a building, a structural material of an edifice, an exterior material, an interior material, a propeller of wind power generation, a solar-cell panel, a cylinder, a piston, an actuator, a damper, a linear guide, a bearing, an engine block, a chassis, a shaft, a rod, an L-shaped metal fitting, a curtain, a roll curtain, a banister/grid/chassis of veranda/balcony/bay window, a handrail of a corridor, a passage, stairs, a bed side, or an inner wall of a bathroom, a chair, a desk, a bookcase, a cupboard, a bed, a bathtub, a toilet seat, a toilet, and the like.

1. An image-information-acquisition fastening member, comprising:
a fastening body including a thread part mountable on a member;
an imaging portion disposed integrally or as a separate body with respect to the fastening body, the imaging portion being configured to capture image information by imaging a surrounding; and
a transmit portion configured to transmit the image information captured by the imaging portion to the outside.

2. The image information acquisition fastening member of claim 1, further comprising:
an analysis portion configured to perform analysis for detecting a detection target from an image captured by the imaging portion,
wherein the transmit portion is configured to transmit information on the detection target detected by the analysis portion to the outside in conjunction with the image information.

3. The image information acquisition fastening member of claim 2, wherein the detection target is corrosion, damage, deformation, loosening of a fastening body, displacement, discoloration, deterioration, a stain, a dropout, a joint gap, an omission, clogging, and/or adhesion of a foreign substance.

4. The image information acquisition fastening member of claim 1, wherein the imaging portion comprises a plurality of optical systems and imaging elements, and
the image-information-acquisition fastening member comprises an image processing portion configured to generate an omnidirectional image by synthesizing images captured by the respective imaging elements.

5. The image information acquisition fastening member of claim 1, wherein the fastening body includes a shaft portion having the thread part on an outer periphery thereof, and
the imaging portion is disposed on an end surface of the shaft portion, and a shape of the imaging portion when viewed in an axial direction of the fastening body fits within a diameter of the shaft portion.

6. The image information acquisition fastening member of claim 1, wherein the fastening body includes a shaft portion having the thread part on an outer periphery thereof, and a head portion formed at one end of the shaft portion, and
the imaging portion is disposed on a front surface of the head portion, and a shape of the imaging portion when viewed in an axial direction of the fastening body fits within an outline of the head portion.

7. The image information acquisition fastening member of claim 1, wherein the fastening body has a nut-shape, and
the imaging portion is disposed on an end surface of the fastening body, and a shape of the imaging portion when viewed in an axial direction of the fastening body fits within an outline of the fastening body.

8. The image information acquisition fastening member of claim 1, further comprising:
a voice acquisition portion configured to acquire a surrounding voice,
wherein the transmit portion is configured to transmit a voice acquired by the voice acquisition portion.

9. The image information acquisition fastening member of claim 1, further comprising:
a position information acquisition portion configured to acquire position information; and
an orientation information acquisition portion configured to acquire orientation information,
wherein the transmit portion is configured to transmit the position information and the orientation information.

10. The image information acquisition fastening member of claim 1, wherein the fastening body includes a thread part by which a plurality of members are fastenable to each other.

11. A monitoring system, comprising:
an image-information-acquisition fastening member comprising a fastening body having a thread part fixable to a member, an imaging portion disposed integrally or as a separate body with respect to the fastening body, the imaging portion configured to capture image information by imaging a surrounding, and a transmit portion configured to transmit the image information to the outside; and
a monitoring device comprising a communication portion capable of communicating with the image-information-acquisition fastening member and configured to receive the image information, and an analysis portion configured to perform analysis for detecting a detection target from an image based on the image information.

12. The monitoring system of claim 11, wherein the detection target is corrosion, damage, deformation, loosening of a fastening body, displacement, discoloration, deterioration, a stain, a dropping, a joint gap, an omission, clogging, and/or adhesion of a foreign substance.

13. The monitoring system of claim 11, wherein the imaging portion comprises a plurality of optical systems and imaging elements, and
the image-information-acquisition fastening member comprises an image processing portion configured to generate an omnidirectional image by synthesizing images captured by the respective imaging elements.

14. The monitoring system of claim 11, wherein the fastening body includes a shaft portion having the thread part on an outer periphery thereof, and
the imaging portion is disposed on an end surface of the shaft portion, and a shape of the imaging portion when viewed in an axial direction of the fastening body fits within a diameter of the shaft portion.

15. The monitoring system of claim 11, wherein the fastening body includes a shaft portion having the thread part on an outer periphery thereof, and a head portion formed at one end of the shaft portion, and
the imaging portion is disposed on a front surface of the head portion, and a shape of the imaging portion when viewed in an axial direction of the fastening body fits within an outline of the head portion.

16. The monitoring system of claim 11, wherein the fastening body has a nut-shape, and
the imaging portion is disposed on an end surface of the fastening body, and a shape of the imaging portion when viewed in an axial direction of the fastening body fits within an outline of the fastening body.

17. The monitoring system of claim 11, wherein the image-information-acquisition fastening member comprises a voice acquisition portion configured to acquire a surrounding voice, and the transmit portion is configured to transmit a voice acquired by the voice acquisition portion.

18. The monitoring system of claim 11, wherein the image-information-acquisition fastening member comprises:
a position information acquisition portion configured to acquire position information; and
an orientation information acquisition portion configured to acquire orientation information, and
the transmit portion is configured to transmit the position information and the orientation information.

19. The monitoring system of claim 11, wherein the monitoring device comprises a display portion configured to display the image information and/or detection target.

20. The monitoring system of claim 11, wherein the monitoring device comprises a notification portion configured to notify that the detection target is being detected.

21. The monitoring system of claim 11, wherein the fastening body includes a thread part by which a plurality of members are fastenable to each other.
